(19) United States
(12) Patent Application Publication
(10) Pub. No.: US 2025/0015503 A1
(43) Pub. Date: Jan. 9, 2025

(54) FOLDED VHF/UHF DIPOLE ANTENNA

(71) Applicant: KYOCERA AVX Components (San Diego), Inc., San Diego, CA (US)

(72) Inventors: Xiaoyan Yuan, San Diego, CA (US); Jesse Shihchieh Hsin, San Diego, CA (US)

(21) Appl. No.: 18/764,621

(22) Filed: Jul. 5, 2024

Related U.S. Application Data
(60) Provisional application No. 63/512,007, filed on Jul. 5, 2023.

(51) Int. Cl. H01Q 9/26

(52) U.S. Cl. CPC H01Q 9/26

(57) ABSTRACT

Dipole antennas for use in the VHF and UHF band are provided. In one example, a dipole antenna includes a linear antenna support. The dipole antenna includes one or more reflector elements positioned on a first section of the antenna support. The dipole antenna includes one or more director elements positioned on a second section of the antenna support. The dipole antenna includes a driven element positioned in a middle section of the antenna support, the middle section being between the first section and the second section. The driven element includes a first leg and a second leg. Each of the first leg and the second leg includes a first conductor extending from the antenna support; a second conductor extending from the first conductor at a direction generally perpendicular to the first conductor; and a third conductor extending from the second conductor.

### PRIORITY CLAIM

The present application claims the benefit of priority of U.S. Provisional App. No. 63/512,007, titled “Folded VHF/UHF Dipole Antenna,” having a filing date of Jul. 5, 2023, which is incorporated by reference herein.

### FIELD

The present subject matter relates generally to very high frequency (VHF) and ultra-high frequency (UHF) dipole antennas for communicating over-the-air (OTA) signals.

### BACKGROUND

An OTA antenna is a device that may be used to receive broadcast television signals over the airwaves. OTA antennas have been traditionally used to receive analog television signals, but with the transition to digital broadcasting, they are now primarily used to receive digital TV signals, often in high definition (HD).

### SUMMARY

Aspects and advantages of embodiments of the present disclosure will be set forth in part in the following description, or may be learned from the description, or may be learned through practice of the embodiments.

One example aspect of the present disclosure is directed to a dipole antenna for very high frequency (VHF) band and ultra-high frequency (UHF) band communications. The dipole antenna includes a linear antenna support. The dipole antenna includes one or more reflector elements positioned on a first section of the antenna support. The dipole antenna includes one or more director elements positioned on a second section of the antenna support. The dipole antenna includes a driven element positioned in a middle section of the antenna support, the middle section being between the first section and the second section. The driven element includes a first leg and a second leg. Each of the first leg and the second leg includes a first conductor extending from the antenna support; a second conductor extending from the first conductor at a direction generally perpendicular to the first conductor; and a third conductor extending from the second conductor.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an example system according to example embodiments of the present disclosure;

FIG. 2 depicts an example dipole antenna according to example embodiments of the present disclosure;

FIG. 3 depicts another example dipole antenna according to example embodiments of the present disclosure;

FIG. 4 depicts yet another example dipole antenna according to example embodiments of the present disclosure;

FIG. 5 depicts an example of simulation results of an example dipole antenna according to example embodiments of the present disclosure; and

FIG. 6 depicts another example of simulation results of an example dipole antenna according to example embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to OTA antennas. In some examples, the driven elements of the OTA antennas are operable to cover the VHF band and the UHF band with highly directive radiation patterns. In some examples, the driven elements can be extended with an additional folded part which can cover the lower VHF frequency band. The OTA antenna can include one or more director elements. The number of director elements can increase or decrease depending on the required radiation power level. The OTA antenna can include one or more reflector elements. The reflector elements can enhance radiation power for the antenna in both the VHF band and UHF band.

In some examples, the OTA antenna is a dipole antenna for VHF band and UHF band communications. The dipole antenna can include a linear antenna support. The dipole antenna can include one or more reflector elements positioned on a first section of the linear antenna support and one or more director elements positioned on a second section of the linear antenna support. The dipole antenna can then include a driven element positioned in a middle section, between the reflector elements and the director elements, of the linear antenna support. The driven element includes a first leg and a second leg. Each of the first leg and the second leg includes a first conductor extending from the linear antenna support, a second conductor extending from the first conductor at a direction generally perpendicular to the first conductor, and a third conductor extending from the second conductor.

As used herein, the term “generally parallel” refers to within 15 degrees of parallel. The term “generally perpendicular” refers to within 15 degrees of perpendicular. The term “about” when used in conjunction with a numerical value refers to within about 10% of the stated amount.

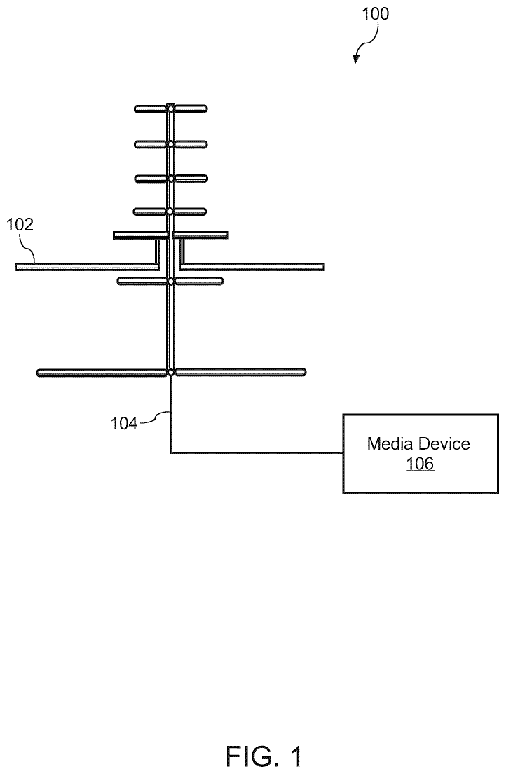

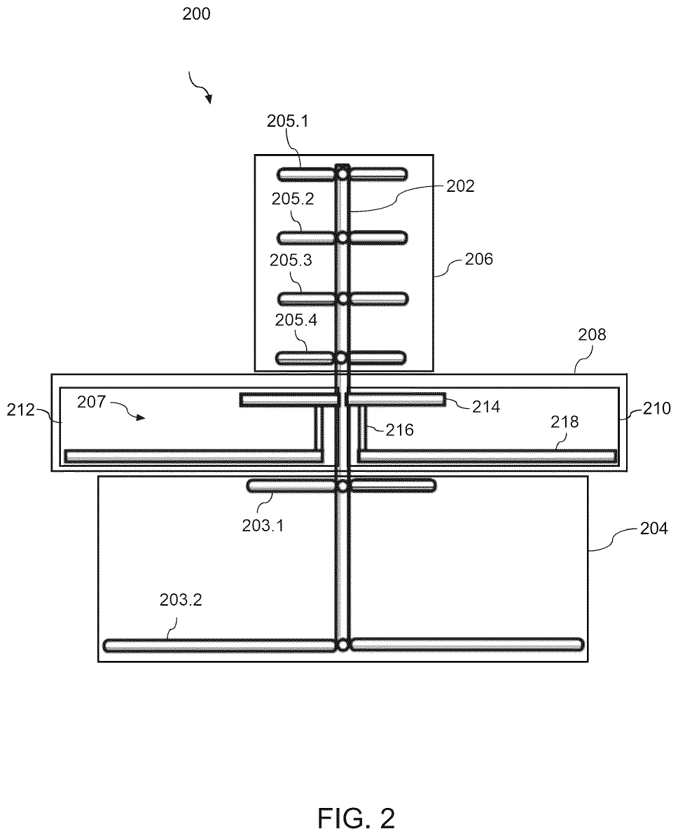

Referring now to the drawings. FIG. 1 depicts an example system 100 for communication of OTA signals according to example embodiments of the present disclosure. The system 100 includes a dipole antenna 102 operable to receive OTA signals in the VHF and/or UHF bands and transmit received OTA signal to a media device 106 via a transmission line 104. The VHF band frequency range may be, for instance, from about 30 to about 300 Megahertz (MHz) and the UHF band frequency range may be, for instance, from about 300 to about 3 Gigahertz (GHz). Details of the dipole antenna 102 will be described below with reference to FIGS. 2-4.

The transmission line 104 that connects the dipole antenna 102 and the media device 106 can be, for instance, a coaxial cable. Coaxial cables are commonly used for connecting the dipole antenna 102 to the media device 106 due to their ability to transmit high-frequency and low-frequency signals with minimal loss and interference. However, in other embodiments, the transmission line 104 can be any other suitable transmission line known in the art, such as various types of coaxial cables, flat cable, twin lead cables, fiber optic cables, or USB cables. Those of ordinary skill in the art, using the disclosures provided herein, will understand that different transmission lines can be used without deviating from the scope of the present disclosure.

The media device 106 that receives OTA signals from the dipole antenna 102 via the transmission line 104 can be, for instance, one or more television sets, set-top boxes, digital TV recorders, streaming devices, laptops and desktops with TV tuner cards, displays with one or more processors, IoT devices, or other suitable devices capable of communicating with the dipole antenna 102 over the transmission line 104. The media device 106 can include one or more processors and one or more memory devices. The one or more memory devices can store computer-readable instructions (e.g., software) that when executed by the one or more memory devices cause the one or more processors to perform operations. The operations can include, for instance, receiving the OTA signals from the dipole antenna 102 via the transmission line 104, decoding the received OTA signals, and providing for display on the media device 106 the content for viewing by a user.

FIG. 2 depicts an example dipole antenna 200 for communication of OTA signals according to example embodiments of the present disclosure. The dipole antenna 200 is for VHF band and UHF band communications. As discussed earlier, the VHF band frequency range may be, for instance, from about 30 to about 300 Megahertz (MHz) and the UHF band frequency range may be, for instance, from about 300 to about 3 Gigahertz (GHz). The dipole antenna 200 can be constructed from a combination of metallic and nonmetallic materials. For example, metallic materials can include aluminum, copper, or steel and nonmetallic materials can include polymeric, fiberglass, or plastic.

The dipole antenna 200 includes a linear antenna support 202. The linear antenna support 202 supports the antenna in a straight configuration. It is used to provide stability, proper alignment, and enhanced signal reception for the antenna. For instance, the linear antenna support 202 can be a vertical pole. It provides height and stability to elevate the antenna above obstructions, such as buildings or trees, for better signal reception.

The dipole antenna 200 also includes one or more reflector elements 203.1, 203.2, . . . 203.n positioned on a first section 204 of the linear antenna support 202. For example, the reflector elements 203.1, 203.2, . . . 203.n may include a top reflector element 203.1 and a bottom reflector element 203.2, which enhance the power for the dipole antenna 200 in the VHF and UHF bands. The reflector elements 203.1, 203.2, . . . 203.n are positioned on the lower section 204 of the linear antenna support 202. It should be appreciated that the number of reflector elements and the sizing and spacing of those can vary depending on the specific design needs for the dipole antenna 200.

The dipole antenna 200 further includes one or more director elements 205.1, 205.2, 205.3, 205.4, . . . 205.n positioned on a second section 206 of the linear antenna support 202. For example, the antenna 200 can include four director elements 205.1, 205.2, 205.3, 205.4 positioned on the upper section of the linear antenna support 202. The number of director elements used in the dipole antenna 200 depends on the required power level. Thus, it should be appreciated that the number of reflector elements and the sizing and spacing of those can vary depending on the specific design needs.

Moreover, the dipole antenna 200 includes a driven element 207 positioned in a middle section 208 between the first section 204 and the second section 206 of the linear antenna support 202. The driven element 207 is folded in a specific way which provides coverage for VHF and UHF bands. For example, the driven element 207 includes a first leg 210 and a second leg 212. The first leg 210 and the second leg 212 are identically designed and mirror one another about the antenna support 202.

Each of the first leg 210 and the second leg 212 includes a first conductor 214 extending from the linear antenna support 202. For example, the first conductor 214 is positioned directly under the director elements 205.1, 205.2, 205.3, 205.4, 205.n and is connected to the linear antenna support 202 and extends outwards from the linear antenna support 202. Each of the first leg 210 and the second leg 212 also includes a second conductor 216 extending from the first conductor 214 at a direction generally perpendicular to the first conductor 214. For example, the upper end of the second conductor 216 is connected to the first conductor 214 near the linear antenna support 202 and extending downwards from the first conductor 214 in a direction generally perpendicular to the first conductor 214. The second conductor 214 is generally parallel to the linear antenna support 202. Each of the first leg 210 and the second leg 212 further includes a third conductor 218 extending from the second conductor 216. For example, the third conductor 218 is connected to the bottom end of the second conductor 216 and extends outwards from the second conductor 216 in a direction generally perpendicular to the second conductor 216. The first conductor 214 and the third conductor 218 are generally perpendicular to the linear antenna support 202 and are generally parallel to each other. The third conductor 218 is longer than the first conductor 214.

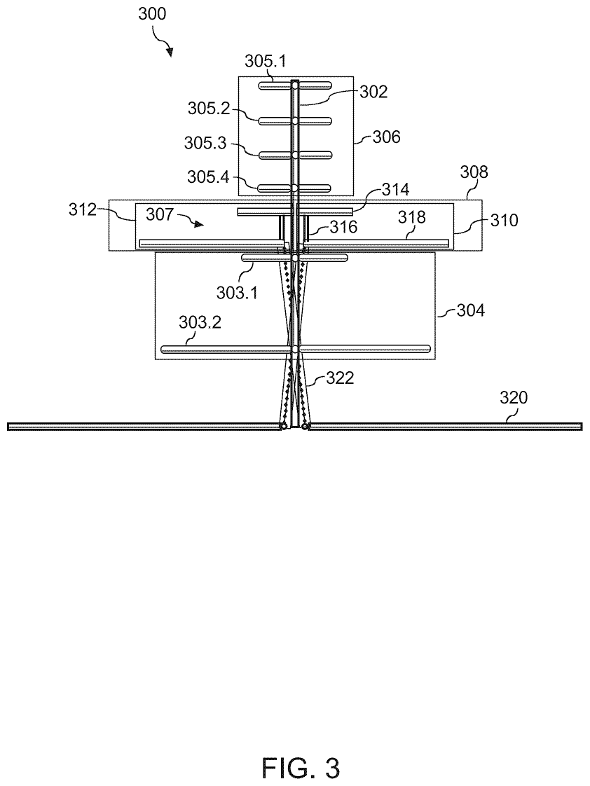

FIG. 3 depicts another example dipole antenna 300 for communication of OTA signals according to example embodiments of the present disclosure. Similar to the dipole antenna 200, the dipole antenna 300 is also for VHF band and UHF band communications. The VHF band frequency range may be, for instance, from about 30 to about 300 Megahertz (MHz) and the UHF band frequency range may be, for instance, from about 300 to about 3 Gigahertz (GHz). The dipole antenna 300 can also be constructed from a combination of metallic and nonmetallic materials.

The dipole antenna 300 includes a linear antenna support 302. The linear antenna support 302 supports the antenna in a straight configuration. The linear antenna support 302 can be, for example, a vertical pole to provide stability, proper alignment, and enhanced signal reception for the antenna. It provides height and stability to elevate the antenna above obstructions, such as buildings or trees, for better signal reception.

The dipole antenna 300 also includes one or more reflector elements 303.1, 303.2, . . . 303.n positioned on a first section 304 of the linear antenna support 302. Similar to the dipole antenna 200, the reflector elements contain a top reflector element 303.1 and a bottom reflector element 303.2 to enhance the power of the antenna 200 in the VHF and UHF bands. The reflector elements 303.1, 303.2, . . . 303.n are positioned towards the lower section of the linear antenna support 302. As described before, the number of reflector elements and the sizing and spacing of those can vary depending on the specific design needs.

The dipole antenna 300 further includes one or more director elements 305.1, 305.2, 305.3, 305.4, . . . 305.n positioned on a second section 306 of the linear antenna support 302. Similar to the dipole antenna 200, the antenna 300 can include four director elements 305.1, 305.2, 305.3, 305.4, . . . 305.n positioned on the upper section of the linear antenna support 302. The number of director elements used in the dipole antenna 300 depends on the required power level. Thus, it should be appreciated that the number of reflector elements and the sizing and spacing of those can vary depending on the specific design needs.

Additionally, the dipole antenna 300 includes a driven element 307 positioned in a middle section 308 between the first section 304 and the second section 306 of the linear antenna support 302. The driven element 307 is generally positioned in the upper half of linear antenna support 302. The driven element 307 is folded in a specific way which provides coverage for VHF and UHF bands. The driven element 307 includes a first leg 310 and a second leg 312. The first leg 310 and the second leg 312 are identically designed and mirror one another about the antenna support 302.

Each of the first leg 310 and the second leg 312 includes a first conductor 314, a second conductor 316, and a third conductor 318. The first conductor 314 is positioned directly under the director elements 305.1, 305.2, 305.3, 305.4, . . . 305.n and is connected to the linear antenna support 302 extending outwards. The second conductor 316 is connected to the first conductor 314 near the linear antenna support 302 and extends downwards from the first conductor 314 in a direction generally perpendicular to the first conductor 314. The third conductor 318 is connected to the second conductor 316 and extends outwards from the second conductor 316 in a direction generally perpendicular to the second conductor 316. The first conductor 314 and the third conductor 318 are generally perpendicular to the linear antenna support 302 and are parallel with each other. The first conductor 314 is also shorter than the third conductor 318. The second conductor 316 is generally parallel to the linear antenna support 302. The second conductor 316 and the third conductor 318 do not touch the linear antenna support 302.

Furthermore, the driven element 307 of the dipole antenna 300 can be extended with an additional folded part to further cover the low VHF band. For example, each of the first leg 310 and the second leg 312 can include a fourth conductor 320 and a cross-conductor 322. The fourth conductor 320 is positioned in the first section 304 of the linear antenna support 302, which is towards the lower section of the linear antenna support 302. The one or more reflector elements 303.1, 303.2, . . . 303.n are between the fourth conductor 320 and the third conductor 318. The cross-conductor 322 is connected to the third conductor 318 where the second conductor 316. The cross-conductor 322 crosses over the linear antenna support 302 and connects the fourth conductor 320. The fourth conductor 320 is longer than the third conductor 318.

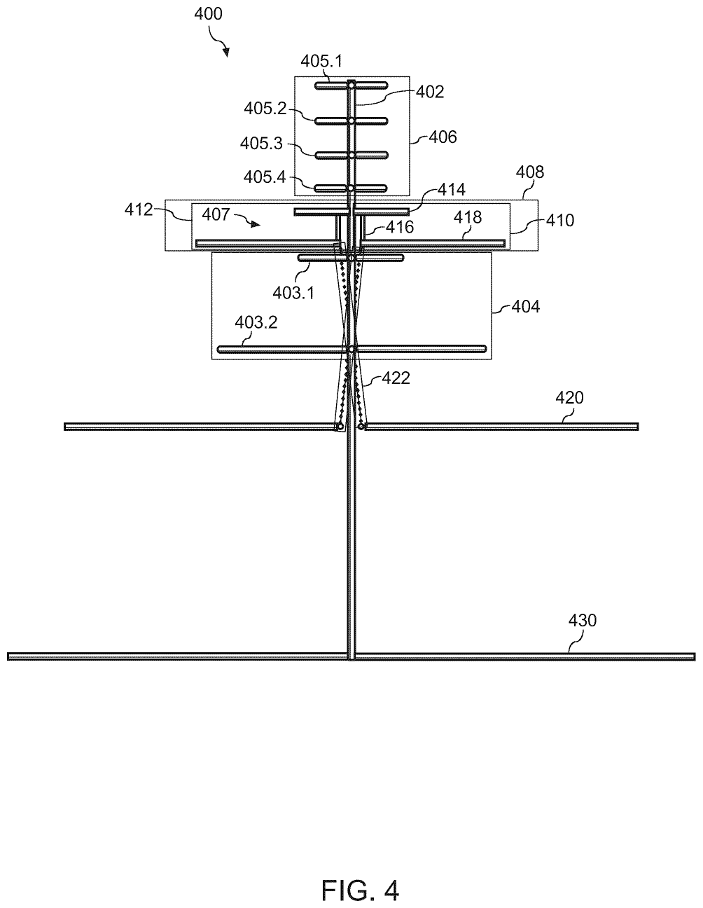

FIG. 4 depicts another example dipole antenna 400 for communication of OTA signals according to example embodiments of the present disclosure. The dipole antenna 400 is used for VHF band and UHF band communications. The VHF band frequency range may be, for instance, from about 30 to about 300 Megahertz (MHz) and the UHF band frequency range may be, for instance, from about 300 to about 3 Gigahertz (GHz). The dipole antenna 400 can also be constructed from a combination of metallic and nonmetallic materials.

The dipole antenna 400 includes a linear antenna support 402. The linear antenna support 402 supports the antenna in a straight configuration. The linear antenna support 402 can be, for example, a vertical pole to provide stability, proper alignment, and enhanced signal reception for the antenna. It provides height and stability to elevate the antenna above obstructions, such as buildings or trees, for better signal reception.

The dipole antenna 400 also includes one or more reflector elements 403.1, 403.2, . . . 403.n positioned on a first section 404 of the linear antenna support 402. The reflector elements contain a top reflector element 403.1 and a bottom reflector element 403.2 to enhance the power of the antenna 200 in the VHF and UHF bands. The reflector elements 403.1, 403.2, . . . 403.n are positioned towards the lower section of the linear antenna support 402. As described before, the number of reflector elements and the sizing and spacing of those can vary depending on the specific design needs.

The dipole antenna 400 further includes one or more director elements 405.1, 405.2, 405.3, 405.4, . . . 405.n positioned on a second section 306 of the linear antenna support 402. The antenna 400 can include four director elements 405.1, 405.2, 405.3, 405.4 positioned on the upper section of the linear antenna support 402. The number of director elements used in the dipole antenna 400 depends on the required power level. Thus, it should be appreciated that the number of reflector elements and the sizing and spacing of those can vary depending on the specific design needs.

Additionally, the dipole antenna 400 includes a driven element 407 positioned in a middle section 408 between the first section 404 and the second section 406 of the linear antenna support 402. The driven element 407 is generally positioned in the upper half of linear antenna support 402. The driven element 407 is folded in a specific way which provides coverage for VHF and UHF bands. The driven element 407 includes a first leg 410 and a second leg 412. The first leg 410 and the second leg 412 are identically designed and mirror one another about the antenna support 402.

Each of the first leg 410 and the second leg 412 includes a first conductor 414, a second conductor 416, and a third conductor 418. The first conductor 414 is positioned directly under the director elements 405.1, 405.2, 405.3, 405.4, . . . 405.n and is connected to the linear antenna support 402 extending outwards. The second conductor 416 is connected to the first conductor 414 near the linear antenna support 402 and extends downwards from the first conductor 414 in a direction generally perpendicular to the first conductor 414. The third conductor 418 is connected to the second conductor 416 and extends outwards from the second conductor 416 in a direction generally perpendicular to the second conductor 416. The first conductor 414 and the third conductor 418 are generally perpendicular to the linear antenna support 402 and are parallel with each other. The first conductor 414 is also shorter than the third conductor 418. The second conductor 416 is generally parallel to the linear antenna support 402. The second conductor 416 and the third conductor 418 do not touch the linear antenna support 402.

Furthermore, the driven element 407 of the dipole antenna 400 can be extended with an additional folded part to further cover the low VHF band. For example, each of the first leg 410 and the second leg 412 can include a fourth conductor 420 and a cross-conductor 422. The fourth conductor 420 is positioned in the first section 404 of the linear antenna support 402, which is towards the lower section of the linear antenna support 402. The one or more reflector elements 403.1, 403.2, . . . 403.n are between the fourth conductor 420 and the third conductor 418. The cross-conductor 422 is connected to the third conductor 418 where the second conductor 416. The cross-conductor 422 crosses over the linear antenna support 402 and connects the fourth conductor 420. The fourth conductor 420 is longer than the third conductor 418.

The antenna 400 can include an additional long-range VHF reflector element 430. The long rang VHF reflector element 430 may be located beneath the fourth conductor 420. The long-range VHF reflector element 430 may be longer than the fourth conductor 420 and may be generally parallel to the fourth conductor 420. The long-range VHF reflector element 430 may be generally perpendicular to the linear antenna support 402.

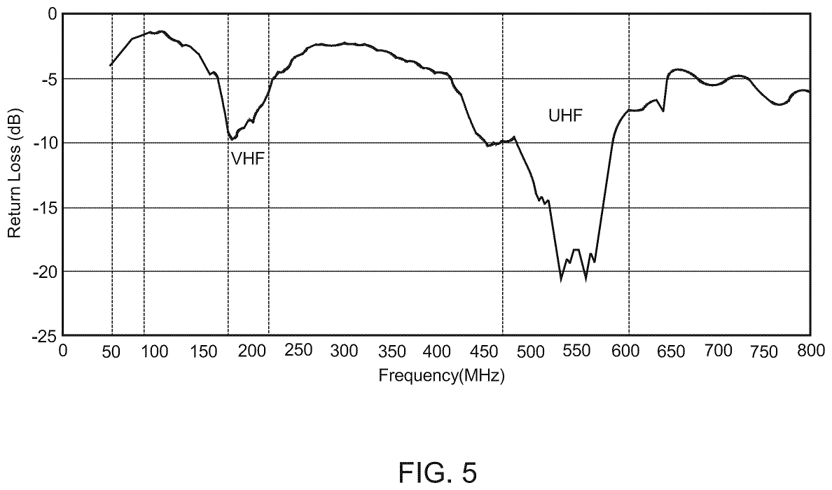

FIG. 5 depicts an example of simulation results of an example dipole antenna according to example embodiments of the present disclosure. FIG. 5 depicts return loss versus frequency for the dipole antenna 200 of FIG. 2. FIG. 5 plots frequency (MHz) along the horizontal axis and return loss (dB) along the vertical axis. As shown, the dipole antenna 200 of FIG. 2 provides good return loss at frequencies in the VHF band and in the UHF band.

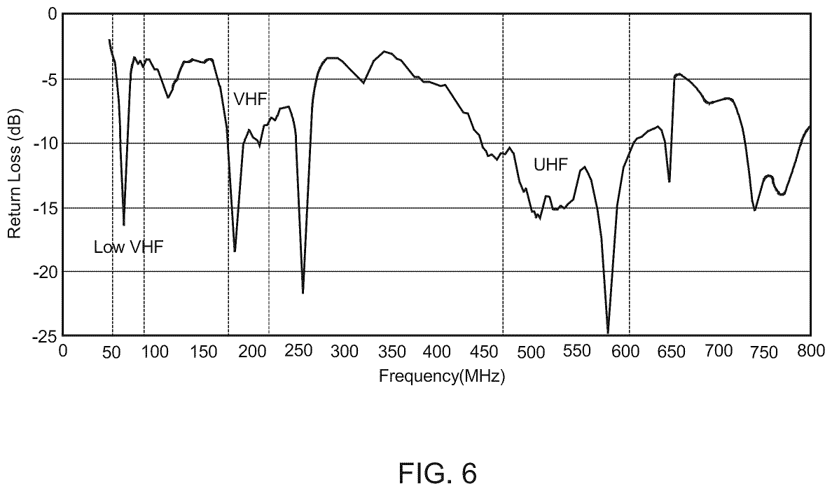

FIG. 6 depicts an example of simulation results of an example dipole antenna according to example embodiments of the present disclosure. FIG. 6 depicts return loss versus frequency for the dipole antenna 300 of FIG. 3. FIG. 6 plots frequency (MHz) along the horizontal axis and return loss (dB) along the vertical axis. As shown, the dipole antenna 200 of FIG. 2 provides good return loss at frequencies in the VHF band, the low VHF band, and in the UHF band.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dipole antenna for very high frequency (VHF) band and ultra-high frequency (UHF) band communications, comprising:
a linear antenna support;
one or more reflector elements positioned on a first section of the antenna support;
one or more director elements positioned on a second section of the antenna support;
a driven element positioned in a middle section of the antenna support, the middle section being between the first section and the second section;
wherein the driven element comprises a first leg and a second leg, each of the first leg and the second leg comprising:
a first conductor extending from the antenna support;
a second conductor extending from the first conductor at a direction generally perpendicular to the first conductor; and
a third conductor extending from the second conductor.

2. The dipole antenna of claim 1, wherein the first leg and the second leg mirror one another.

3. The dipole antenna of claim 1, wherein the first conductor and the third conductor are generally perpendicular to the antenna support.

4. The dipole antenna of claim 1, wherein the third conductor is generally parallel to the first conductor.

5. The dipole antenna of claim 1, wherein the third conductor is longer than the first conductor.

6. The dipole antenna of claim 1, wherein the second conductor is generally parallel to the antenna support.

7. The dipole antenna of claim 1, wherein each of the first and the second leg further comprises:
a fourth conductor; and
a cross-conductor connecting the fourth conductor to the third conductor, wherein the cross-conductor crosses over the antenna support.

8. The dipole antenna of claim 7, wherein the fourth conductor is in the first section of the antenna support such that the one or more reflector elements are between the fourth conductor and the third conductor.

9. The dipole antenna of claim 7, wherein the fourth conductor is longer than the third conductor.

10. The dipole antenna of claim 1, wherein the VHF band frequency range is from about 30 to about 300 Megahertz (MHz) and the UHF band frequency range is from about 300 to about 3 Gigahertz (GHz).

11. A dipole antenna for very high frequency (VHF) band and ultra-high frequency (UHF) band communications, comprising:
a linear antenna support;
one or more reflector elements positioned on a first section of the antenna support;
one or more director elements positioned on a second section of the antenna support;
a driven element positioned in a middle section of the antenna support, the middle section being between the first section and the second section;
wherein the driven element comprises:
a first leg and a second leg;
a conductor positioned in the first section of the antenna support; and
a cross-conductor connecting the conductor to the first leg and the second leg of the driven element, wherein the cross-conductor crosses over the antenna support.

12. The dipole antenna of claim 11, wherein the first leg and the second leg mirror one another.

13. The dipole antenna of claim 11, wherein the conductor is in the first section of the antenna support such that the one or more reflector elements are between the first leg and the conductor.

14. The dipole antenna of claim 11, wherein the conductor is longer than the driven element.

15. A system, comprising:
a media device;
an antenna;
a transmission line connecting the antenna to the media device;
wherein the antenna comprises:
a linear antenna support;
one or more reflector elements positioned on a first section of the antenna support;
one or more director elements positioned on a second section of the antenna support;
a driven element positioned in a middle section of the antenna support, the middle section being between the first section and the second section;
wherein the driven element comprises a first leg and a second leg, each of the first leg and the second leg comprising:
a first conductor extending from the antenna support;
a second conductor extending from the first conductor at a direction generally perpendicular to the first conductor; and
a third conductor extending from the second conductor.

16. The system of claim 15, wherein the first leg and the second leg mirror one another.

17. The system of claim 15, wherein the first conductor and the third conductor are generally perpendicular to the antenna support.

18. The system of claim 15, wherein the second conductor is generally parallel to the antenna support.

19. The system of claim 15, wherein each of the first and the second leg further comprises:
a fourth conductor; and
a cross-conductor connecting the fourth conductor to the third conductor, wherein the cross-conductor crosses over the antenna support.

20. The system of claim 19, wherein the fourth conductor is in the first section of the antenna support such that the one or more reflector elements are between the fourth conductor and the third conductor.
